(19) United States
(12) Patent Application Publication
(10) Pub. No.: US 2005/0282692 A1
(43) Pub. Date: Dec. 22, 2005

(54) Removable flexible roller

(76) Inventor: Galen Redden, Shawnee Mission, KS (US)

Correspondence Address: Hovey Williams LLP, Suite 400, 2405 Grand Blvd., Kansas City, MO, 64108, US

(21) Appl. No.: 10/872,153

(22) Filed: Jun. 17, 2004

(51) Int. Cl. B25F 5/02

(52) U.S. Cl. 492/40; 492/47

(57) ABSTRACT

A removable flexible roller assembly (10) broadly comprises a rigid and rotatable cylindrical core (200) having a plurality of longitudinal slots (214) and at least one radial slot (216), a resilient roller (202) operable to longitudinally slide along the core (200) and having a plurality of internal longitudinal splines (226) that slide into the longitudinal slots (214) of the core (200), thereby preventing rotation of the roller (202) with respect to the core, and a retaining ring (218) operable to selectively fit into and extend radially from the radial slot (216) of the core (200), thereby selectively preventing the roller (202) from sliding substantially with respect to the core (200).

### BACKGROUND OF THE INVENTION

1. Field of the Invention

The present invention relates to material handling rollers. More particularly, the present invention relates to a removable flexible roller assembly that may be easily disassembled and rebuilt in order to replace worn components.

2. Description of Prior Art

Rollers are commonly used in many material handling applications. For example, rollers are used in battery plate assembly machines to transport battery plates, such as those used in lead acid batteries. Such rollers may either drive the plates directly or indirectly through conveyor belts. In either case, such rollers must be resilient or flexible in order to securely grip the plates without damaging them.

Motors and other equipment must transfer power to operate such rollers through rigid shafts and other devices. The rollers are therefore typically bonded to the drive shafts with adhesives to prevent the rollers from slipping relative to the drive shafts.

During normal operation, the flexible material of the rollers often becomes worn and unusable, and therefore must frequently be replaced. However, as the flexible material is typically bonded to the drive shafts, entire roller assemblies must be replaced. While it is possible to remove and replace the flexible material on a shaft using chemical solvents, such operations are typically complex, tedious, and costly. Of course, either replacing the entire roller assembly or breaking a bond between a roller and a shaft requires excessive expense and leads to inefficiencies.

Accordingly, there is a need for an improved roller assembly that overcomes the limitations of the prior art.

### SUMMARY OF THE INVENTION

The present invention overcomes the above-identified problems and provides a distinct advance in the art of material handling rollers. More particularly, the present invention provides a removable flexible roller assembly that may be easily disassembled and rebuilt in order to replace worn components. In one embodiment, the roller assembly is used in a battery plate handling machine to directly or indirectly transport battery plates, such as those used in lead acid batteries. The roller assembly broadly comprises a core, at least one roller that may slide along the core, and at least one retainer to selectively prevent the roller from sliding along the core.

The core is preferably rigid and cylindrical to provide a stable and rotatable support for the roller. The core preferably includes a longitudinal hole centered therein, into which a shaft may be inserted. In preferred embodiments, the core is preferably selectively rigidly secured to the shaft, and therefore rotates with the shaft. For example, the core may include one or more radial through holes. The holes may be threaded to accept set screws which may be used to secure the core to the shaft. Alternatively, the holes may be smooth and accept a spring pin designed to penetrate into the shaft, thereby locking the core to the shaft.

The core also preferably includes four slots that extend longitudinally along the core and inwardly of an exterior diameter of the core. As will be discussed in further detail below, the longitudinal slots allow the rollers to slide longitudinally along the core while preventing the rollers from rotating with respect to the core. The core also preferably includes one or more radial slots that extend inwardly around the core's exterior diameter. Each radial slot may accept a retaining ring in order to selectively prevent the rollers from sliding along the core. In any case, the core preferably includes at least one roller mounting surface to accept the roller.

Each roller preferably includes a cylindrical interior wall sized to snugly fit over the roller mounting surface and a cylindrical exterior wall designed to engage the plates directly or through conveyor belts. The interior wall preferably includes a plurality of longitudinal splines extending inwardly therefrom. The splines slide into the longitudinal slots of the core as the roller is slid onto the core. Thus, the splines mate the roller with the core and prevent the roller from rotating with respect to the core.

As the exterior wall imparts driving force to the plates, it is preferably resilient, such that it flexes inwardly in response to excessive pressure from the plates. Specifically, the exterior wall preferably flexes enough to avoid damaging one of the plates or other equipment. For example, a plurality of longitudinal tunnels may be formed between the interior and exterior walls, allowing the exterior wall to collapse inwardly in response to the pressure. Side walls of the tunnels connect the interior wall to the exterior wall, thereby allowing the core to control rotation of the exterior wall.

The retainer may simply comprise one or more retaining rings fitted into the radial slots. In this case, radial slots are preferably located at each end of the roller mounting surface. The retaining rings fit into and extend radially outward from each of the radial slots, thereby preventing the roller from sliding with respect to the core. Of course, any of the retaining rings may be removed, thereby allowing the roller to longitudinally slide in one or more directions with respect to the core. However, due to the interaction between the longitudinal slots and the splines, the roller is still prevented from rotating with respect to the core.

It should be noted that use of retaining rings adjacent each end of the roller mounting surface allows the roller to be removed and replaced from either end of the core. However, the retainer may also comprise lands or radially extending walls that protrude from the core adjacent one end of the roller mounting surface. For example, the lands may extend from the core adjacent inboard ends of the roller mounting surfaces. The rollers would be allowed to slide onto the core, but would be stopped at the lands, thereby seating the rollers on the roller mounting surfaces. In this case, retaining rings would still preferably be used at outboard ends of the roller mounting surfaces to hold the rollers against the lands and on the roller mounting surfaces. In this manner, the rollers could still be easily removed from the core by removing the retaining rings and sliding the rollers outwardly away from the lands.

The roller assembly may also include cylindrical shims to occupy any available space between the rollers and the retainer. Therefore, use of the shims allows the rollers to be used with roller mounting surfaces of different sizes. Additionally, the shims may be used to seal off the tunnels, thereby preventing debris from accumulating therein and influencing the flexibility of the rollers.

To assemble the roller assembly, the retaining rings are fitted into one of the radial slots adjacent the inboard ends of the roller. The rollers are then slid onto the core from the outboard ends. Finally, additional retaining rings are fitted into the radial slot adjacent the outboard ends of the roller mounting surfaces. In this manner, the rollers are secured to the core. Reversing this procedure allows the rollers to be removed from the core, in order to replace worn or otherwise unsuitable rollers. It should be noted that the core may be mated with the shaft either with or without the rollers secured to the core.

When assembled, the roller assembly may be placed into service virtually anywhere in the machine. As the rollers or other components wear, the worn components may be replaced quickly, easily, and without any special tools. Specifically, because the rollers are not bonded to the core or the shaft, they may be quickly and easily replaced. In this manner, the roller assembly of the present invention reduces required labor, materials, and expense in operating the machine, thereby making the machine more efficient and profitable.

### BRIEF DESCRIPTION OF THE DRAWINGS

A preferred embodiment of the present invention is described in detail below with reference to the attached drawing figures, wherein:

FIG. 1 is a schematic layout in plan view of a battery plate handling machine that may utilize a roller assembly constructed in accordance with a preferred embodiment of the present invention;

FIG. 2 is an elevational view of an automatic plate feeder station and a lug brush cleaning station of the machine taken along line 2-2 of FIG. 1;

FIG. 3 is an elevational view of a plate alignment station and a plate encapsulation station of the machine;

FIG. 4 is a expanded perspective view of a preferred first embodiment of the roller assembly;

FIG. 5 is a perspective view of the first embodiment of the roller assembly shown substantially assembled;

FIG. 6 is a expanded perspective view of a preferred second embodiment of the roller assembly; and

FIG. 7 is a perspective view of the second embodiment of the roller assembly shown substantially assembled.

### DETAILED DESCRIPTION OF A PREFERRED EMBODIMENT

Referring to the figures, the preferred roller assembly 10 constructed in accordance with a preferred embodiment of the present invention is illustrated as part of a battery plate manufacturing and/or handling machine 12. More specifically, the roller assembly 10 may be used as part of a plate handling apparatus, such as that described in U.S. Pat. No. 5,934,866, entitled “PLATE FEEDER APPARATUS”, incorporated herein by specific reference. Additionally, or alternatively, the roller assembly 10 of the present invention may be used as part of a plate feeding and handling apparatus, such as that described in U.S. Pat. No. 6,024,533, entitled “BATTERY PLATE FEEDING AND HANDLING APPARATUS”, incorporated herein by specific reference.

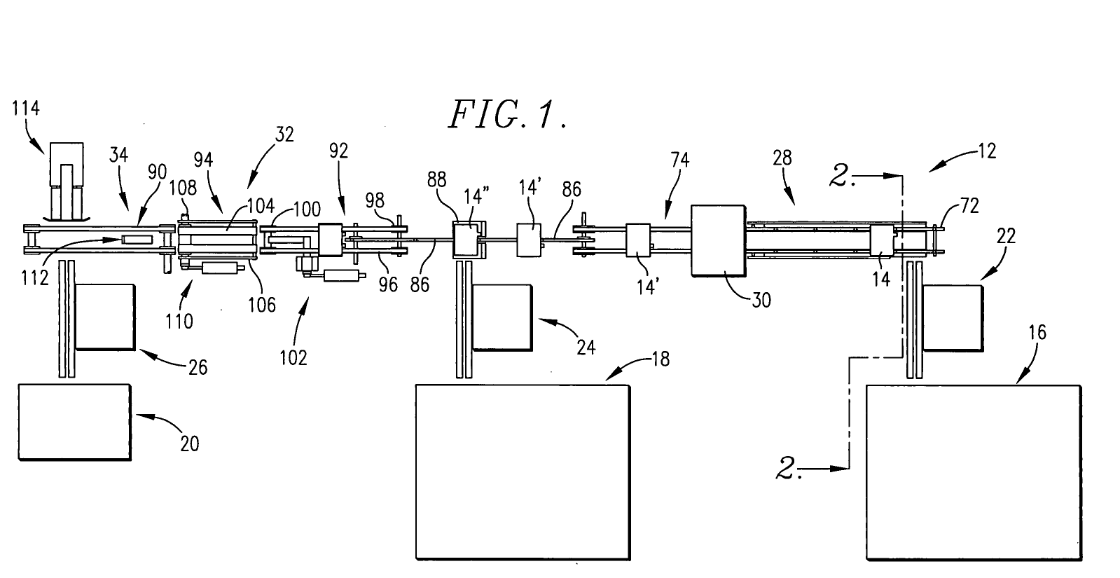

In any case, as shown in FIG. 1, the machine 12 is preferably configured for handling battery plates 14, such as lead plates used in the construction of lead acid batteries. As such, the machine 12 may include a pair of automatic plate feeder and pickup stations 16,18, a manual plate feeder station 20, a plurality of lug brush cleaning stations 22-26, a plate alignment station 28, a plate encapsulating station 30, a plate rejection station 32, and/or a plate synchronization station 34. Each of these stations are fully described in the above referenced U.S. patents, and therefore will not be discussed in great detail here.

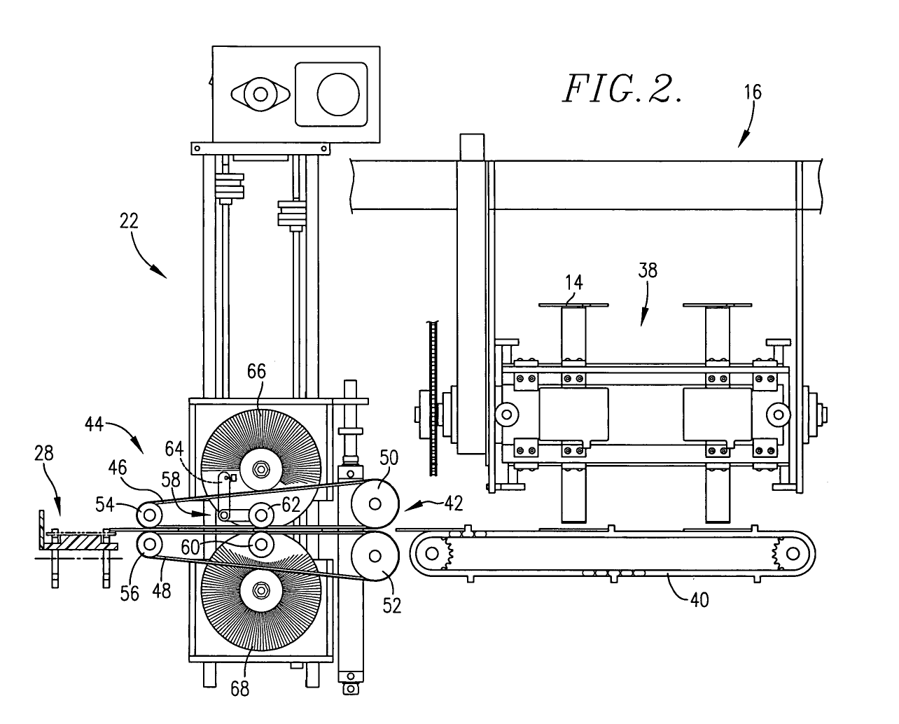

Referring also to FIG. 2, the automatic plate feeder and pickup stations 16,18 are preferably substantially identical. Therefore, only the automatic plate feeder and pickup station 16 is described herein. In general, the automatic plate feeder and pickup station 16 includes a plate feeder conveyor (not shown) that holds and sequentially feeds at least one stack of plates 14 towards a plate pick-up 38. The plate pickup 38 successively picks or removes the forward-most plate 14 from each stack of plates 14 and then drops the plates 14 one at a time onto a conveyor 40, which carries the plates 14 to other processing stations.

The manual plate feeder station 20 is preferably entirely conventional and includes a conveyor (not shown) on which the plates 14 may be manually placed for transport to the lug brush cleaning mechanism 26. The manual plate feeder station 20 is typically used only when batteries requiring an odd number of plates are to be manufactured. The plate feeder conveyor and the conveyor of the manual plate feeder station 20 are preferably substantially identical to the conveyor 40 of the automatic plate feeder and pickup station 16 discussed above.

The lug brush cleaning stations 22-26 are provided for each of the automatic plate feeder and pickup stations 16,18, and the manual plate feeder station 20, respectively. The lug brush cleaning stations 22-26 are preferably substantially identical. Therefore, only the lug brush cleaning station 22 is described herein. The lug brush cleaning station 22 preferably includes a conveyor 42 that receives and transports the plates 14 from the above discussed conveyors and a brush mechanism 44 for cleaning each plate's 14 lugs as the plates 14 are transported on the conveyor 42.

The conveyor 42 preferably includes a pair of vertically stacked upper and lower conveyor belts 46,48 that are each trained around a drive roller 50,52 and an idler roller 54,56, and a biasing mechanism 58 for biasing the conveyor belts 46,48 into contact with one another. The drive rollers 50,52 are vertically spaced a small distance apart to define a nip region therebetween for gripping the plates 14 as they exit the above discussed conveyors and introducing the plates 14 between the two conveyor belts 46,48.

The biasing mechanism 58 includes a fixed roller 60 positioned below the upper portion of the lower conveyor belt 48 and a spring-biased roller 62 positioned above the lower portion of the upper conveyor belt 46. The spring-biased roller 62 is coupled with a spring and lever mechanism 64 that exerts a downward force on the spring-biased roller 62 so that the spring-biased roller 62 exerts a downward force on the upper conveyor belt 46. This biases the conveyor belts 46,48 into contact with one another to prevent the plates 14 between the conveyors belts 46,48 from moving relative to the conveyor belts 46,48 as their lugs are being cleaned by the brush mechanism 44. This also allows both of the conveyor belts 46,48 to be driven by a single drive line if desired. The downward force exerted on the spring-biased roller 62 by the lever mechanism 64 can be selectively adjusted to provide the optimum amount of pressure between the two conveyor belts 46,48.

The brush mechanism 44 includes a pair of vertically stacked upper and lower rotatable brushes 66,68 each driven by a separate motor (not shown). The brushes 66,68 are preferably formed of steel and are approximately 10″ in diameter and ½″ thick.

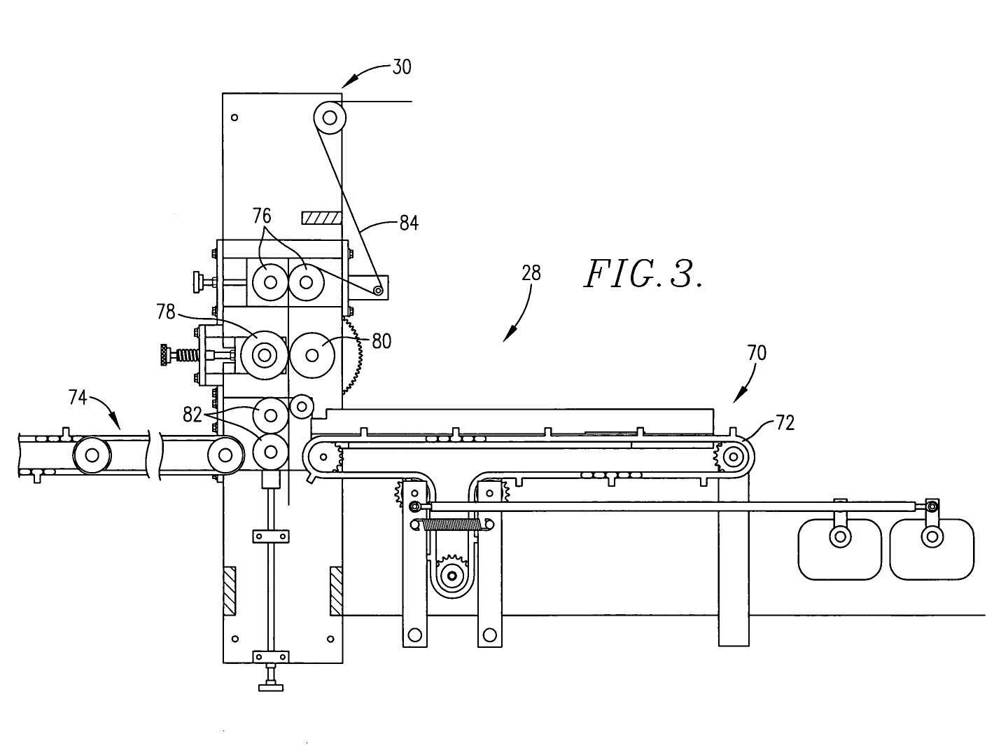

Referring also to FIG. 3, the plate alignment station 28 receives the plates 14 after they have been cleaned by the lug brush cleaning mechanism 22 and advances the plates 14 to the plate encapsulation station 30. The plate alignment station 28 allows an operator to easily adjust the orientation or alignment of the plates 14 before they enter the plate encapsulation station 30 to ensure that insulation is properly applied to the plates 14. The plate alignment station 28 includes a conveyor 70 having a pair of side-by-side chains or belts 72.

The plate encapsulating station 30 receives the plates 14 from the plate alignment station 28 and applies insulation to the plates 14 before discharging them to another conveyor 74. The plate encapsulating station 30 includes a pair of feed rollers 76, a cutoff roller 78 and an anvil roller 80, and a pair of nip rollers 82. The feed rollers 76 feed a web of insulation material 84 from a roll station (not shown) to the cutoff roller 78 and the nip rollers 82 for application to the plates 14 as they pass between the nip rollers 82.

Once the plates 14 have been wrapped, the conveyor 74 carries the plates 14 to a single chain conveyor 86, as illustrated in FIG. 1. As a wrapped plate 14′ is deposited on the conveyor 86, the second lug brush cleaning station 24 delivers an unwrapped plate 14″ to a perch 88 that is mounted slightly above the conveyor 86. The perch 88 has a slot along the length thereof that is parallel to the travel of the conveyor 86. As the conveyor 86 carries the wrapped plate 14′ under the perch 88, a protrusion on the conveyor 86 contacts and removes the unwrapped plate 14″ from the perch 88 so that it is stacked on top of the wrapped plate 14′. The conveyor 86 then carries the wrapped and unwrapped plates 14 to the plate rejection station 32.

The plate rejection station 32 receives the wrapped and unwrapped plates 14 from the conveyor 86 and delivers them to a final conveyor 90 that transports the plates 14 to a stacking assembly (not shown). The plate rejection station 32 is operable for rapidly rejecting damaged or otherwise defective plates before they reach the final conveyor 90.

The plate rejection station 32 includes a pair of horizontally aligned first and second conveyors 92,94 each having a receiving end and a discharge end. The first conveyor 92 includes a pair of belts 96 that are trained over a pair of idler rollers 98, at the receiving end, and a pair of drive rollers 100, at the discharge end, and a positioning mechanism 102 for selectively lowering the discharge end of the first conveyor 92. Similarly, the second conveyor 94 includes a pair of belts 104 that are trained over an idler roller 106 and a drive roller 108, and a positioning mechanism 110 for selectively raising a receiving end of the second conveyor 94.

During normal operating conditions, the first and second conveyors 92,94 are shifted to their operating positions so that the plates 14 may pass from the first conveyor 92 to the second conveyor 94. However, when a defective plate is detected, the first and second conveyors 92,94 are shifted to their rejection positions so that the defective plate drops from the first conveyor 92 before it reaches the second conveyor 94.

The final conveyor 90 receives the plates 14 that have not been rejected by the plate rejection station 32 and transports the plates 14 to a stacking assembly (not shown). The plate synchronization station 34 is provided for temporarily suspending the transport of the plates 14 on the final conveyor 90 so that the stacking assembly and other stations downstream of the machine 12 can be operated. Then, when the plates 14 are ready to be once again transported downstream, the plate synchronization station 34 accurately places the plates 14 in proper order so that the transport of the plates 14 through the machine 12 is synchronized with the operations that occur downstream of the machine 12.

The plate synchronization station 34 includes a mini-stack assembly 112 and a perch assembly 114. The mini-stack assembly 112 is positioned between the final conveyor's 90 belts and includes a support tray having an upstanding backwall that serves as a stop and a cylinder for selectively raising and lowering the tray. When the tray is lowered, the final conveyor 90 transports the plates 14 toward the stacking assembly without interruption. However, when the tray is raised, the tray temporarily suspends the forward travel of the plates 14. The mini-stack assembly 12 may be manually operated or may be coupled with a PLC or other controller so that it is automatically operated in sequence with the stacking assembly.

The perch assembly 114 is operably coupled with the lug brush cleaning mechanism 26 of the manual plate feeder station 20 and includes a horizontally disposed platform, a cylinder for selectively extending and retracting the platform, and a fixed backstop. When the platform is extended, it catches any plate delivered by the manual plate feeder station 20. When the platform is retracted, it slides underneath the backstop so that the plate 14 supported thereon is dropped onto the final conveyor 90. The perch assembly 114 is operated in sequence with the mini-stack assembly 112 so that the perch assembly 114 drops it's the plates 14 at a precise location relative to the plates 14 that are carried on the final conveyor 90 and released by the mini-stack assembly 112.

The roller assembly 10 of the present invention may be used in place of and/or in conjunction with any of the rollers of the machine 12 discussed above. Additionally, and/or alternatively, the roller assembly 10 of the present invention may be used in place of, in conjunction with, and/or to drive any of the conveyors of the machine 12 discussed above.

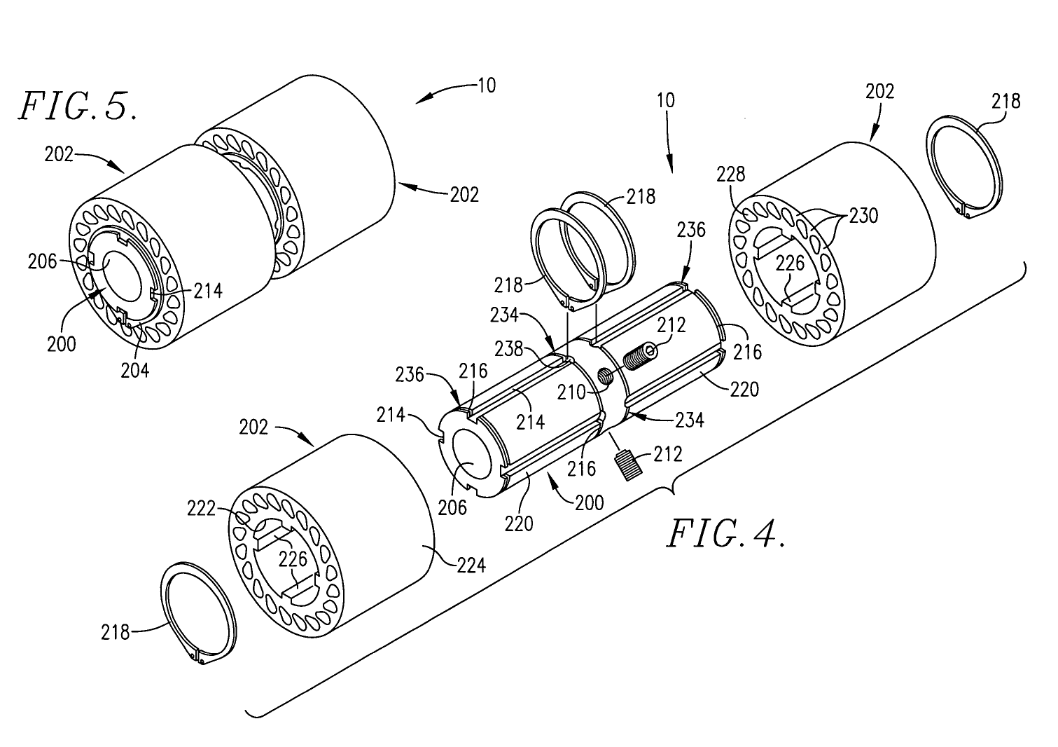

As shown in FIGS. 4-7, the roller assembly 10 of the present invention broadly comprises a core 200, at least one roller 202 that may slide along the core 200, and at least one retainer 204 to selectively prevent the roller 200 from sliding along the core 200. The core 200 is preferably rigid and cylindrical to provide a stable and rotatable support for the roller 202.

The core 200 preferably includes a longitudinal hole 206 centered longitudinally along the core 200, into which a shaft 208 may be inserted. The core 200 may rotate about the shaft 208 or may rotate with the shaft 208. For example, the core 200 may be secured to the shaft 208 through a bearing or lubricant may be injected between the core 200 and the shaft 208. In this configuration, the core 200 may rotate freely about the shaft 208.

However, in preferred embodiments, the core 200 is preferably selectively rigidly secured to the shaft 208, and therefore rotates with the shaft 208. For example, the core 200 may include one or more radial through holes 210. The holes 210 may be centered along the core 200 or may be located near one end of the core 200. The holes 210 may also be threaded to accept set screws 212 which may be used to secure the core 200 to the shaft 208. Alternatively, the holes 210 may be smooth and accept a spring pin 213 designed to penetrate into the shaft 208, thereby locking the core 200 to the shaft 208.

The core 200 also includes one or more longitudinal slots 214 that extend longitudinally and inwardly of an exterior diameter of the core 200 and one or more radial slots 216 that extend inwardly around the core's 200 exterior diameter. As will be discussed in further detail below, the longitudinal slots 214 allow the rollers 202 to slide longitudinally along the core 200 while preventing the rollers 202 from rotating with respect to the core 200. Each radial slot 216 may accept a retaining ring 218 in order to selectively prevent the rollers 202 from sliding along the core 200. In any case, the core 200 preferably includes at least one roller mounting surface 220 to accept the roller 202.

Each roller 202 preferably includes a cylindrical interior wall 222 sized to snugly fit over the roller mounting surface 220 and a cylindrical exterior wall 224 designed to engage the plates 14 directly or through the belts of the conveyors. The interior wall 222 preferably includes a plurality of longitudinal splines 226 extending inwardly therefrom. The splines 226 slide into the longitudinal slots 214 of the core 200 as the roller 202 is slid over the core 200. Thus, the splines 226 mate the roller 202 with the core 200 and prevent the roller 202 from rotating with respect to the core 200.

The exterior wall 224 actually engages and imparts driving force to either the plates 14 directly or through the belts of the conveyors. Therefore, the exterior wall 224 is preferably resilient, such that the exterior wall 224 may collapse inwardly in response to excessive pressure from the plates 14 or another source. However, the exterior wall 224 preferably does not collapse completely, rather the exterior wall 224 preferably flexes only enough to avoid damaging the plates 14 or other equipment. Thus, a plurality of longitudinal tunnels 228 are preferably formed between the interior and exterior walls 222,224. Side walls 230 of the tunnels 228 connect the interior wall 222 to the exterior wall 224, thereby allowing the core 200 to control rotation of the exterior wall 224.

The side walls 230 also allow slight temporary variations in rotational speed of the exterior wall 224 with respect to the core 200. For example, as the exterior wall 224 flexes, thereby absorbing force that would otherwise be transferred to the plates 14, the side walls 230 bend slightly. As the side walls 230 bend, the exterior wall 224 momentarily slows down slightly, while the core 200 maintains a constant speed. When the force is removed or reduced, the side walls 230 straighten. As the side walls 230 straighten, the exterior wall 224 momentarily speeds up slightly, while the core 200 maintains the constant speed. It should be noted however, such variations in speed between the exterior wall 224 and the core 200 are limited by the side wall's 230 height and are expected to be minimal. Furthermore, the shape of the tunnels 228 and side walls 230 may be manipulated to either increase or reduce the variations in speed.

The rollers 202 are preferably made of a urethane compound and may have any one of a variety of durameter ratings, such as a durameter rating of 65, 70, 75, or 80. The rollers 202 may also come in a variety of colors, such as blue, red, orange, or black. The color of the roller 202 is preferably associated with the durameter rating in order to make selection of the proper roller as easy as possible. For example, where the roller's 202 durameter rating is 65, the roller 202 is preferably blue. Similarly, where the roller's 202 durameter rating is 70, the roller 202 is preferably red. Likewise, where the roller's 202 durameter rating is 75, the roller 202 is preferably orange. Finally, where the roller's 202 durameter rating is 80, the roller 202 is preferably black.

The retainer 204 may simply comprise the retaining rings 218 fitted into the radial slots 216. In this case, radial slots 216 are preferably located at each end of the roller mounting surface 220. The retaining rings 218 fit into and extend radially outward from each of the radial slots 216, thereby preventing the roller 202 from sliding with respect to the core 200. Of course, any of the retaining rings 218 may be selectively removed, thereby selectively allowing the roller 202 to longitudinally slide in one or more directions with respect to the core 200. However, due to the interaction between the longitudinal slots 214 and the splines 226, the roller 202 is still prevented from rotating with respect to the core 200.

It should be noted that use of retaining rings 218 adjacent each end of the roller mounting surface 220 allows the roller 202 to be removed and replaced from either end of the core 200. However, the retainer 204 may also comprise lands or radially extending walls that protrude from the core 200 adjacent one end of the roller mounting surface 220. For example, the lands may extend from the core 200 adjacent inboard ends 234 of the roller mounting surfaces 220. The rollers 202 would be allowed to slide onto the core 200, but would be stopped at the lands, thereby seating the rollers 202 on the roller mounting surfaces 220. In this case, retaining rings 218 would still preferably be used at outboard ends 236 of the roller mounting surfaces 220 to hold the rollers 202 against the lands and on the roller mounting surfaces 220. In this manner, the rollers 202 could still be easily removed from the core 200 by removing the retaining rings 218 and sliding the rollers 202 outwardly away from the lands.

Alternatively, the retainer 204 may comprise end walls 238 in the longitudinal slots 214. The end walls 238 function similarly to the lands and are preferably located adjacent the inboard ends 234 of the roller mounting surfaces 220. More specifically, the end walls 238 prevent the splines 226 from sliding past the inboard ends 234 of the roller mounting surfaces 220, thereby preventing the rollers 202 from sliding past the inboard ends 234 of the roller mounting surfaces 220. Like the lands, the end walls 238 may only be placed at one end of the roller mounting surface 220 and are preferably placed adjacent the inboard ends 234.

The roller assembly 10 may also include cylindrical shims 240 to occupy any available space between the rollers 202 and the retainer 204. Therefore, use of the shims 240 allows the rollers 202 to be used with roller mounting surfaces 220 of different sizes. Additionally, the shims 240 may be used to seal off the tunnels 228, thereby preventing debris from accumulating therein and influencing the flexibility of the rollers 202.

Now turning to a specific first embodiment, as shown in FIGS. 4-5, the core 200 is approximately five and three quarter inches long with an approximately one and three quarter inch external diameter and an approximately one inch internal diameter. The core 200 is constructed from a rigid material, such as steel, aluminum, rigid plastic, composites, or any other suitable material.

The core 200 includes two roller mounting surfaces 220, one near each end, with radial slots 216 at both inboard and outboard ends 234,236 of the roller mounting surfaces 220, which are approximately two and three eighths inches long. Thus, the roller assembly 10 shown in FIGS. 4-5 uses four retaining rings 218. The core 200 also includes four longitudinal slots 214 extending from the inboard ends 234 through the outboard ends 236 of the roller mounting surfaces 220. Finally, the core 200 has two holes 210 that are threaded to accept the set screws 212, so that the core 200 may be secured to the shaft (not shown) having an approximately one inch external diameter. The holes are approximately five sixteenths of an inch in diameter, with a #18 thread, and extend through the core's 200 approximately three eights of an inch thickness.

The rollers 202 are approximately two and three eighths inches in length and have an approximately one and three quarter inch internal diameter from which four splines 226 extend inwardly. As above, the rollers 200 may have a variety of durameter ratings and/or colors.

To assemble this roller assembly 10, the retaining rings 218 are first fitted into the radial slots 216 adjacent the inboard ends 234 of the roller mounting surfaces 220. The rollers 202 are then slid onto the core 200 from each end. Finally, the retaining rings 218 are fitted into the radial slots 216 adjacent the outboard ends 236 of the roller mounting surfaces 220. In this manner, the rollers 202 are secured to the core 200. Reversing this procedure allows the rollers 202 to be removed from the core 200, in order to replace worn or otherwise unsuitable rollers. It should be noted that the core 200 may be mated with the shaft 208 either with or without the rollers 202 secured to the core 200.

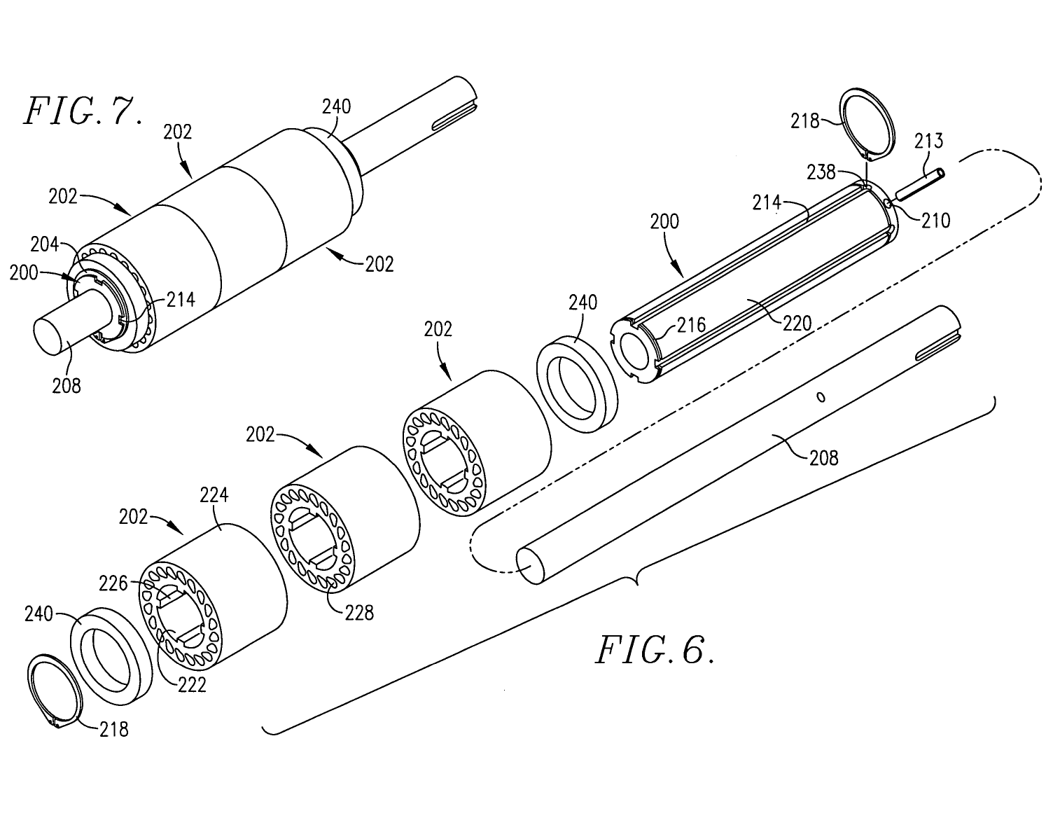

Now turning to a specific second embodiment, as shown in FIGS. 6-7, the core 200 is approximately eight and one half inches long with an approximately one and three quarter inch external diameter and an approximately one inch internal diameter.

The core 200 includes one roller mounting surface 220 designed to accommodate three rollers 202, with radial slots 216 at both a left and a right end of the roller mounting surface 220, which is approximately seven and five eighths inches long. Thus, the roller assembly 10 shown in FIGS. 4-5 uses two retaining rings 218. The core 200 also includes four longitudinal slots 214 extending through the entire length of the roller mounting surface 220. Finally, the core 200 has one hole 210 that is smooth to accept the spring pin 213, so that the core 200 may be secured to the shaft 208 having an approximately one inch external diameter. The hole 210 is approximately one quarter inch in diameter and extends through the core's 200 approximately three eights of an inch thickness. The spring pin 213 is preferably one quarter inch in diameter and approximately one and three quarter inches long to fit through the core 200 and into the shaft 208.

The rollers 202 are approximately two and three eighths inches in length and have an approximately one and three quarter inch internal diameter from which the four splines 226 extend inwardly. As above, the rollers 200 may have a variety of durameter ratings and/or colors. Furthermore, as the roller mounting surface 220 is approximately one half inch longer than the three rollers, this roller assembly 10 preferably includes two quarter inch shims 240 located at opposite ends of the roller mounting surface 220.

To assemble this roller assembly 10, one of the retaining rings 218 is first fitted into the radial slots 216 adjacent either the right or the left end of the roller mounting surface 220. One of the shims 240 is then slid onto the core 200 from the other end. The rollers 202 are then slid onto the core 200 from the other end. The other shim 240 is then slid onto the core 200 from the other end. Finally, the other retaining ring 218 is fitted into the radial slots 216 adjacent the other end of the roller mounting surface 220. In this manner, the rollers 202 are secured to the core 200. Reversing this procedure allows the rollers 202 to be removed from the core 200, in order to replace worn or otherwise unsuitable rollers. It should be noted that the core 200 may be mated with the shaft 208 either with or without the rollers 202 secured to the core 200.

It should be noted that the slots 214,216 are to be sized to according to the application and available standard sizes. For example, where the rollers 202 may be expected to experience significant torque, the longitudinal slots 214 and corresponding splines 226 may need to be larger than in other applications. Alternatively, a designer may simply add more longitudinal slots 214 and splines 226 where needed. Additionally, the radial slots 216 are preferably sized to accept retaining rings 218 that are commonly available to fit the core 200.

While the present invention has been described above, it is understood that substitutions may be made. For example, rather than using the set screw 212 or spring pin 213 discussed above, the core 200 may be secured to the shaft 208 using other techniques, such as a drift pin. Alternatively, the core 200 and the shaft 208 may be combined into one integrally formed unit. For example, where the machine 12 cannot accept a shaft having a large diameter roller mounting surface, the separate core 200 and shaft 208 is preferably used. However, where there are no such restrictions, the core 200 and shaft 208 may be combined, thereby simplifying assembly and use of the roller assembly 10.

Additionally, particularly where the core 200 has only one roller mounting surface 220, the lands or end walls 238 may be located at a right or left end of the roller mounting surface 200, rather than the inboard end 234, as discussed above. Furthermore, either the entire roller 202 or substantially just the exterior wall 224 of the roller 202 may be resilient. Finally, other materials and/or dimensions may be used. These and other minor modifications are within the scope of the present invention.

Furthermore, the roller assembly 10 of the present invention may also be used outside of the machine 12 as part of virtually any battery plate manufacturing and/or handling machine. In fact, the roller assembly 10 of the present invention may be used separately from any battery plate manufacturing and/or handling machine. For example, the roller assembly 10 of the present invention may be used in virtually any material handling application to either directly or indirectly assist in moving virtually any material. Specific applications will determine specific materials from which the roller assembly 10 should be constructed, as well as sizes of the roller assembly 10 and its components.

1. A roller assembly comprising:
a rigid and rotatable core;
a resilient roller operable to longitudinally slide along the core and configured to prohibit rotation with respect to the core; and
a retainer that may be selectively connected to the core to prevent the roller from sliding substantially with respect to the core and disconnected from the core to permit the roller to be removed from the core.

2. The roller assembly as set forth in claim 1, wherein the core includes a radial slot and the retainer includes a retaining ring operable to fit into and extend radially from the radial slot, thereby selectively preventing the roller from sliding along the core.

3. The roller assembly as set forth in claim 1, wherein the core includes two roller mounting surfaces and four radial slots and the retainer includes four retaining rings operable to fit into and extend radially from the radial slots, thereby selectively preventing the roller from sliding along the core, with each pair of radial slots flanking one of the two roller mounting surfaces.

4. The roller assembly as set forth in claim 1, wherein the core includes one roller mounting surface which is longer than the roller.

5. The roller assembly as set forth in claim 4, wherein the roller mounting surface is covered by three rollers.

6. The roller assembly as set forth in claim 4, wherein the roller mounting surface is covered by two shims.

7. The roller assembly as set forth in claim 1, wherein the roller includes longitudinal tunnels allowing an exterior wall of the roller to flex in response to excessive pressure.

8. The roller assembly as set forth in claim 1, wherein the roller is not bonded to the core or a shaft.

9. A roller assembly comprising:
a rigid and rotatable cylindrical core having a plurality of longitudinal slots and at least one radial slot;
a resilient roller operable to longitudinally slide along the core and configured to prohibit rotation with respect to the core having a plurality of internal longitudinal splines that slide into the longitudinal slots of the core, thereby preventing rotation of the roller with respect to the core; and
a retaining ring operable to selectively fit into and extend radially from the radial slot of the core, thereby selectively preventing the roller from sliding substantially with respect to the core.

10. The roller assembly as set forth in claim 9, wherein the core has four longitudinal slots and the roller has four splines.

11. The roller assembly as set forth in claim 9, wherein the core has two radial slots and the roller assembly includes two retainer rings.

12. The roller assembly as set forth in claim 9, wherein the core has two roller mounting surfaces with each roller mounting surface flanked by two radial slots and the roller assembly includes two rollers and four retainer rings with each retainer ring fitted into one of the radial slots in order to prevent the two rollers from sliding along the core.

13. The roller assembly as set forth in claim 9, wherein the core has one roller mounting surface flanked by two radial slots and the roller assembly includes three rollers, two retainer rings with each retainer ring fitted into one of the radial slots in order to prevent the two rollers from sliding along the core, and two shims each located between one of the rollers and one of the retainer rings in order to center the rollers on the roller mounting surface.

14. The roller assembly as set forth in claim 9, wherein the roller is not bonded to the core or a shaft.

15. A battery plate handling machine for handling battery plates, the machine comprising:
a plate feeder station to feed the plates;
a lug brush cleaning station to clean the plates' lugs as the plates pass by from the feeder station;
a plate encapsulating station to wrap selected plates in insulation material; and
wherein at least one of the stations includes a roller assembly having
a rigid and rotatable cylindrical core having a plurality of longitudinal slots and at least one radial slot,
a resilient roller operable to longitudinally slide along the core and configured to prohibit rotation with respect to the core having a plurality of internal longitudinal splines that slide into the longitudinal slots of the core, thereby preventing rotation of the roller with respect to the core, and
a retainer clip operable to selectively fit into and extend radially from the radial slot of the core, thereby selectively preventing the roller from sliding substantially with respect to the core.

16. The machine as set forth in claim 15, wherein the core has four longitudinal slots and the roller has four splines.

17. The machine as set forth in claim 15, wherein the core has two radial slots and the roller assembly includes two retainer rings.

18. The machine as set forth in claim 15, wherein the core has two roller mounting surfaces with each roller mounting surface flanked by two radial slots and the roller assembly includes two rollers and four retainer rings with each retainer ring fitted into one of the radial slots in order to prevent the two rollers from sliding along the core.

19. The machine as set forth in claim 15, wherein the core has one roller mounting surface flanked by two radial slots and the roller assembly includes three rollers, two retainer rings with each retainer ring fitted into one of the radial slots in order to prevent the two rollers from sliding along the core, and two shims each located between one of the rollers and one of the retainer rings in order to center the rollers on the roller mounting surface.

20. The machine as set forth in claim 15, wherein the roller is not bonded to the core or a shaft.
